(19) United States
(12) Patent Application Publication
(10) Pub. No.: US 2008/0198825 A1
(43) Pub. Date: Aug. 21, 2008

(54) System and method for transmitting data packages with a classification mechanism of priority grade

(75) Inventor: Yung-Chi Fan, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 12/068,210

(22) Filed: Feb. 4, 2008

(30) Foreign Application Priority Data
Feb. 2, 2007 (TW) 96103963

(51) Int. Cl. H04Q 7/24; H04B 7/00

(52) U.S. Cl. 370/338; 370/310

(57) ABSTRACT

A system and method for transmitting data packages with a priority grade, which applies to a processing procedure of transmitting a data package from an application layer to WLAN device is provided. The system includes at least an analysis module and a QoS classifier. The analysis module is used to analyze the contents of data package transmitted from the application layer, to classify and to record the data or type of service (ToS) of the data package. The QoS classifier is used to mark the priority grade on the data package according to the classification and the record made by the analysis module.

### BACKGROUND OF THE INVENTION

1. Field of the Invention

The invention relates to a system for transmitting data packages and, more particularly, to a system for transmitting data packages with a priority grade.

2. Description of the Related Art

With the improvement of the science and technology and the demand for the portable communication such as the mobile phone or the notebook which needs to access the Internet wirelessly and the popularity and maturity of the wireless local area network (WLAN), the WLAN almost all use the medium access control (MAC), protocol of IEEE 802.11. However, conditional IEEE 802.11 MAC layer does not pay attention to the problems of quality of service (QoS), so that the transmission of some instant information such as multimedia audio or video streaming may be intermittent or motionless for it cannot be processed prior or the bandwidth which can be used of the network is unsteady.

To improve the QoS mechanism of WLAN, IEEE 802.11 task group put forward IEEE 802.11e communication protocol IEEE 802.11e standard improves carrier sense multiple access with collision avoidance (CSMA/CA) medium access manner and adds enhanced distribution coordination function (EDCF) and hybrid controlled channel access (HCCA) access mechanism to enhance the function of QoS mechanism. Therefore, the QoS mechanism of IEEE 802.11e can make the instant information (such as multimedia audio or video streaming) having a high priority grade processed prior, so that the transmission of the information is more smooth and steady.

However, preset WLAN device supporting the QoS mechanism of IEEE 802.11e cannot distinguish the priority grade of each data package actively. Therefore, the WLAN device all expects that the application program of the upper layer must add some marks such as the type of service (ToS) column of the IP header to data package having a high priority (such as multimedia data) actively to enable the WLAN device make a priority sequencing according to the marks.

However, most preset application program does not mark or classify actively. Therefore, the WLAN device in bottom layer cannot distinguish the priority order of the data package, and then the efficiency of QoS mechanism of IEEE 802.11e is not obvious. That is, the data package having a high priority cannot be assured to be transmitted prior, which may cause the transmission of the data to be intermittent. For example, the instant multimedia audio or video streaming may be intermittent or delayed.

Therefore, since the conventional technology still has defects, a plan resolving the problems effectively is provided and is necessary for the present technology.

### BRIEF SUMMARY OF THE INVENTION

One objective of the invention is to mark a data package with a priority grade before the data package is transmitted to the WLAN device.

Another objective of the invention is to make transmission sequence of the data package before the data package is received by the WLAN device according to the priority grade, so as to ensure that important data package having high priority.

Another objective of the invention is to mark a higher priority grade on the audio or video multimedia steaming data package to ensure the constant bandwidth of the multimedia streaming data.

The invention provides a system for transmitting data packages with a priority grade, which is applied to a processing procedure of transmitting a data package from an application layer to WLAN device. The system at least includes an analysis module and a QoS classifier. The analysis module is used to analyze the content of the data package transmitted by the application layer, classify and record data or type of service: (ToS) of the data package. The QoS classifier is used to mark a priority grade on the data package according to the classification and record made by the analysis module.

The invention provides a method for transmitting data packages having a classification mechanism of a priority grade, which is applied to a processing procedure of transmitting a data package from an application layer to WLAN device. The method includes the steps of analyzing the content of a data package, classifying and recording the data or ToS of the data package, marking a priority grade on the data package according to the classification and the record.

These and other features, aspects, and advantages of the present invention will become better understood with regard to the following description, appended claims, and accompanying drawings.

### BRIEF DESCRIPTION OF THE DRAWINGS

FIG. 1 is a schematic diagram showing a system for transmitting with a classification mechanism of a priority grade according to an embodiment of the invention.

FIG. 2 is a flowchart showing the transmission method with a classification mechanism of a priority grade according to the embodiment of the invention.

### DETAILED DESCRIPTION OF THE EMBODIMENTS

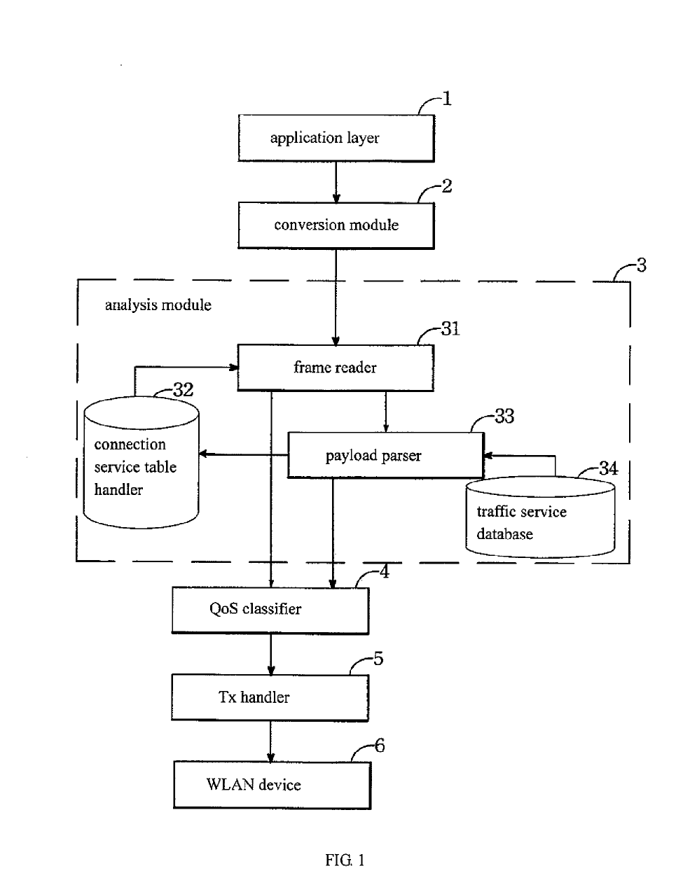

Please refer to FIG. 1, which is a schematic diagram showing a system for transmitting data packages with a priority grade. The system for transmitting with a classification mechanism of a priority grade is applied to a processing procedure of transmitting a data package from an application layer 1 to WLAN device 2. In the preferred embodiment, the WLAN device is based on IEEE 802.11e communication protocol, and the system for transmitting data packages exists in a WLAN firmware layer between the application layer 1 and the WLAN device 2.

As shown in FIG. 1, the system for transmitting data packages of the invention includes a conversion module 2, an analysis module 3, a QoS classifier 4 and a Tx handler 5. The conversion module 2 has an IEEE 802.11 protocol stack and can convert the frame format of the data package from the application layer 1 to the frame format of the IEEE 802.11. Generally speaking, the frame format transmitted from the application layer 1 is a frame format of the IEEE 802.3 standard.

The analysis module 3 is used to analyze the content of the data package transmitted by the application layer 1, classify and record the data or type of service (ToS) of the data package. The QoS classifier 4 is used to mark a priority grade on the data package according to the classification and the record made by the analysis module 3. The ToS includes the source address, source port number, destination address, destination port number of the data package.

In the embodiment of the invention, the analysis module 3 includes a frame reader 31, a connection service table 32, a payload parser 33 and a traffic service database 34.

The connection service table 32 has a piece of contrast data. When the analysis module 3 analyzes the data package, it can analyze the data or ToS of the data package according to the connection service table 32.

The frame reader 31 is used to read the content of the header of the data package, and the frame reader 31 can read according to the contrast data of the connection service table 32. The frame reader 31 mainly reads the type, source address, destination address of the data package. The type of the data package includes the real-time transport protocol (RTP), real time streaming protocol (RTSP) or type of service (ToS) and so on.

When the frame reader 31 can read the content of the header of the data package efficiently, it classifies and records the data or ToS of the data package, and then, the QoS classifier 4 marks the priority grade of the data package.

When the frame reader 31 cannot red the content of the header of the data package efficiently, the data package is transmitted to the payload parser 33 to directly analyze the content of the payload of the data package to obtain the data or ToS of the data package. In the process of analyzing the content of the payload of the data package by the payload parser 33, a piece of contrast data is also needed, and the payload parser 33 analyzes according to the contrast data, and the contrast data is provided by a traffic service database 34. That is, the traffic service database 34 of the analysis module 3 is used to provide another contrast data which is used to be a basis for the payload parse 33 to analyze the content of the payload of the data package.

When the payload parser 33 can efficiently analyze the content of the payload of the data package, it classifies and records the data or the ToS of the data package, and then, QoS classifier 4 marks the priority grade on the data package.

Since the payload parser 33 can directly analysis the content of the payload of the data package to obtain the data or ToS of the data package, in one embodiment, the analysis of the data package also can be done by the payload parser 33 directly without passing the frame reader 31.

Since the payload parser 33 analyzes the content of the payload of the data package by examining byte one by one, and this process is time-consuming and affects the whole transmission efficiency.

Therefore, in the preferred embodiment, if the content of the header of the data package can be read by the flame reader 31 efficiently, it can be analyzed just by frame reader 31 without using the payload parser 33. Then, the whole transmission efficiency is increased.

In addition, since the process that payload parser 33 analyzes the content of the payload of the data package is time-consuming, the payload parser 33 records the data or ToS of the data package which has been analyzed by itself to the contrast data of the connection service table 32 dynamically. If the data package with the same ToS is transmitted to the system later, the flame reader 31 can read according to the contrast data of the connection service table 32 directly, and the payload parser 33 does not need to analyze the data package with the same ToS again, and then the usage number of times of the payload parser 33 is decreased.

Since the present audio or video multimedia information becomes more and more plentiful, and the instantaneity and the smoothness in the playing are emphasized, that is, the intermittent or motionless condition is not wanted in the playing, in the preferred embodiment of the invention, when the data package is audio or video multimedia data, the priority grade marked thereon is higher.

At last, the Tx handler 5 of the system for transmitting data packages in the invention is used to transmit the data package on which a priority grade is marked by the QoS classifier 4 to the WLAN device 6.

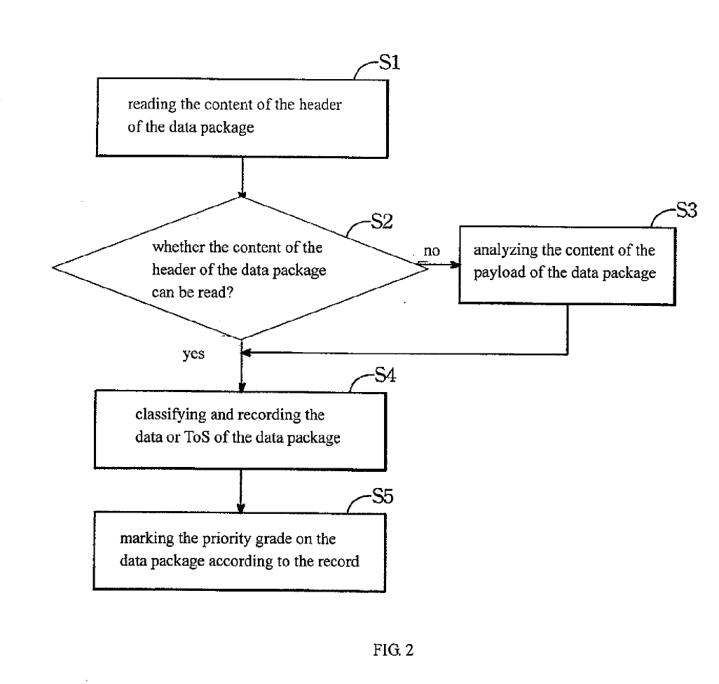

Please refer to FIG. 2, which is a flowchart showing a transmission method for transmitting data packages with a priority grade. The transmission method is applied to a processing procedure of transmitting a data package from an application layer to WLAN device. The method includes the main steps of analyzing the content of a data package, classifying and recording the data or the ToS of the data package, and marking a priority grade on the data package according to the classification and the record to enable the WLAN device to make a sequencing of the QoS mechanism. The detailed steps are described hereinbelow.

After the data package is transmitted by the application layer, the frame format transmitted by a usual application layer is a frame format conforming to the standard of the IEEE 802.3, and therefore, the frame format of the data package should be converted to the frame format conforming to the IEEE 802.11. Then, a piece of contrast data of the connection service table is captured, and the content of the header of the data package is read according to the contrast data (S1), wherein the content includes the type, source address, destination address of the data package. In the process of reading the content of the header of the data package, whether the content of the header of the data package can be read effectively should be confirmed (S2).

If the content of the header of the data package cannot be efficiently read, another contrast data of a traffic service database is captured to further analyze the content of the payload of the data package (S3), and the analysis result is recorded to the connection service table as the contrast data of the connection service table. Then, the data or ToS of the data package are classified and recorded according to the result of reading the content of the header of the data packet or analyzing the content of the payload of the data packet (S4). A prior grade is marked on the data package according to the classification and the record (S5). In the preferred embodiment, the data package whose content is multimedia audio or video data is marked a higher priority grade. At last, the data package is transmitted to the WLAN device.

To sum up, the system and method for transmitting data packages with a priority grade provided by the invention has the following advantages.

First, a priority grade can be marked at the data package before the data package is transmitted to the WLAN device and the sequencing of the QoS mechanism is performed.

Second, the transmission sequence of the data package has been ordered in sequence according to the priority grade before the data package is received by the WLAN device to ensure that the important data package with a high priority grade can be transmitted prior, and the efficiency of data transmission on the Internet can be improved.

Third, the transmission sequence of the data package has been ordered in sequence according to the priority grade before the data is received by the WLAN device, and a higher prior grade is given to the audio and video multimedia streaming data to ensure the instantaneity of and the constant bandwidth of the multimedia streaming data.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A system for transmitting data packages with a priority grade, the system applied to a processing procedure of transmitting a data package from an application layer to wireless local area network (WLAN) device, the system comprising:
an analysis module for analyzing the content of the data package transmitted by the application layer, classifying and recording the data or the type of service (ToS) of the data package; and
a quality of service (QoS) classifier for marking a priority grade on the data package according to the classification and record made by the analysis module.

2. The system according to claim 1, wherein the analysis module further comprises a connection service table having a contrast data, and then the analysis module can analyze the data or the type of service (ToS) of the data package according to the connection service table.

3. The system according to claim 2, wherein the analysis module further comprises a frame reader for reading the content of the header of the data package, and the flame reader can read according to the connection service table.

4. The system according to claim 3, wherein the analysis module further comprises a payload parser, and when the frame reader cannot read the data or the type of service (ToS) of the data package, the payload parser can analyze the content of the payload of the data package to obtain the data or the type of service (ToS) of the data package.

5. The system according to claim 4, wherein the analysis module further comprises a traffic service database for providing another contrast data, and the payload parser can analyze the content of the payload of the data package according to the contrast data.

6. The system according to claim 4, wherein the connection service table can record the data or the type of service (ToS) of the data package which is analyzed by the payload parser.

7. The system according to claim 1, wherein the analysis module further comprises a payload parser for analyzing the content of the payload of the data package to obtain the data or the type of service (ToS) of the data package.

8. The system according to claim 7, wherein the analysis module further comprises a traffic service database for providing a contrast data, and the payload parser can analyze the content of the payload of the data package of the data package according to the contrast data.

9. The system according to claim 1, wherein the system further comprises a conversion module having IEEE 802.11 protocol stack which can be used to convert the frame format of the data package transmitted from the application layer to the frame format of IEEE 802.11.

10. The system according to claim 3, wherein the frame reader is used mainly to read the type, the source address, the destination address of the data package.

11. The system according to claim 11, wherein the type of the data package comprises the real-time transport protocol (RIP), the real time streaming protocol (RTSP) or the type of service (ToS).

12. The system according to claim 1, wherein the type of service (ToS) comprises a source address, a source port number, a destination address, a destination port number of the data package.

13. The system according to claim 1, wherein the system further comprises a Tx handler for transmitting the data package on which the priority grade is marked by the quality of service (QoS) classifier to the wireless local area network (WLAN) device.

14. The system according to claim 13, wherein the wireless local area network (WLAN) device is based on IEEE 802.11e.

15. The system according to claim 1, wherein when the data package is video or audio multimedia data, the priority grade marked thereon is higher.

16. A transmission method for transmitting data packages with a priority grade, the system applied to a processing procedure of transmitting a data package from the application layer to wireless local area network (WLAN) device, the transmission method comprising the steps of:
analyzing the content of the data package;
classifying and recording the data or the type of service (ToS) of the data package; and
marking a priority grade on the data package according to the classification and the record.

17. The method according to claim 16, wherein the step of analyzing the content of the data package further comprises the step of: capturing contrast data of a connection service table.

18. The method according to claim 17, wherein step of analyzing the content of the data package further comprises the step of reading the content of header of the data package.

19. The method according to claim 18, wherein step of analyzing the content of the data package further comprises the step of: analyzing the content of the payload of the data package when the content of the header of the data package cannot be read.

20. The method according to claim 19, wherein the step of analyzing the content of the payload of the data package further comprises the step of: capturing the contrast data of a traffic service database.

21. The method according to claim 20, wherein the step of classifying and recording the data or the type of service (ToS) of the data package further comprises the step of recording the result of analyzing the content of the payload of the data package to the connection service table.

22. The method according to claim 16, wherein the step of analyzing the content of the data package further comprises the step of: analyzing the content of the payload of the data package.

23. The method according to claim 22, wherein the step of analyzing the content of the payload of the data package further comprises the step of: capturing the contrast data of a traffic service database.

24. The method according to claim 16, further comprising the step of converting the frame format of the data package to the frame format of the IEEE 802.11 before the step of analyzing the content of the data package.

25. The method according to claim 18 further comprising the step of: reading the type, the source address, the destination address of the data package.

26. The method according to claim 16, further comprising the step of transmitting the data package to the wireless local area network (WLAN) device after the step of marking the priority grade on the data package.

27. The method according to claim 16, wherein the step of marking the priority grade on the data package further comprises the step of: marking a high priority grade on the data package whose content is multimedia video or audio data.
